(19) United States
(12) Patent Application Publication
(10) Pub. No.: US 2010/0205038 A1
(43) Pub. Date: Aug. 12, 2010

(54) TRAVEL MARKET ANALYSIS TOOLS

(75) Inventors: JOHN MICHAEL RAUSER, SEATTLE, WA (US); JAMES THEODORE BARTOT, SEATTLE, WA (US); DAVID WEI HSU, DECATUR, GA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/368,883

(22) Filed: Feb. 10, 2009

(51) Int. Cl. G06Q 50/00; G06F 17/30

(52) U.S. Cl. 705/10; 707/E17.044; 705/306

(57) ABSTRACT

A method, system, and medium are provided for market intelligence tools for travel arrangements. A travel arrangement can be optimized by collecting and analyzing past event data for a desired travel selection. A data analysis engine aggregates, analyzes, and stores historical data of average travel ticket prices, as a function of the day of the year, for a travel selection. Another database analysis includes aggregating day-of-the-week data by the data analysis engine, wherein average travel ticket prices are given as a function of the day of the week, for both the departure day and the return day. Another database analysis includes aggregating advance purchase time data by the data analysis engine, wherein average travel ticket prices are given as a function of the number of days prior to a departure date. These database analyses are combined to form probabilities for the best and worst times to purchase travel tickets.

### BACKGROUND

There is a huge variance in travel costs, depending upon the time of year in which travelling occurs, the departure date and return date of the travel period, and how far in advance travel arrangements are finalized, along with several other factors. Therefore, selecting optimal parameters for travel is very desirable.

Travelers typically determine a general time period in which they wish to travel. After beginning to actively start shopping, they periodically check current prices for several potential travel dates. This procedure entails looking at prices over potentially several possible travel date combinations, and deciding whether to purchase any one of those options, or wait and hope for a better price in the future.

The means to determine optimal travel parameters, however, requires a great deal of independent research on the part of the traveler. Various tools are available to ascertain the cost of future travel arrangements, such as flight tickets. Many different combinations of travel factors need to be inputted, such as the time of year, departure and return dates, departure and return times, and for airlines travel, the departure and return airports. This produces a large amount of output data. In addition, historical data is not immediately available for consideration as input.

### SUMMARY

Embodiments of the invention are defined by the claims below. A high-level overview of various embodiments of the invention is provided to introduce a summary of the systems, methods, and media that are further described in the detailed description section below. This summary is neither intended to identify key features or essential features of the claimed subject matter, nor is it intended to be used as an aid in isolation to determine the scope of the claimed subject matter.

In the several embodiments of the invention, market intelligence tools are used to optimize travel arrangements. Data from past events is analyzed and applied to current travel ticket prices by a data analysis engine. The data analysis engine aggregates historical data, in which several travel ticket prices are given as a function of the days of the year. The data analysis engine provides analytical results of the historical data to illustrate the most expensive times of the year, along with the most inexpensive times of the year. The data analysis engine also aggregates day-of-the-week data, in which several travel ticket prices are given as a function of the day of the week, for both departure days and return days. The data analysis engine provides analytical results of the day-of-the-week data to illustrate the best and worst times in which to depart and return. The data analysis engine also aggregates advance purchase time data, in which several travel ticket prices are given as a function of the number of days prior to the departure date. The data analysis engine provides analytical results of the advance purchase time data to assist in determining how long to wait (or not to wait) to purchase a travel ticket.

The data results described above are combined and analyzed by the data analysis engine to provide probabilities as to the best combination of departure and return days, departure and return dates, length of trip, and when to purchase a travel ticket with respect to the number of days before departure. A user interface provides a menu for customizing several different variables at each level of an analysis process. A database listing of the cheapest travel tickets available, according to specified user input, is produced by the data analysis engine and displayed through a user selected link.

A system of several databases, including an historical database, a day-of-the-week database, and an advance purchase time database is used. The results of these databases are combined and analyzed, to provide a probability database and a listing of the cheapest travel tickets, according to user selected input. These results and a price listing of the cheapest travel tickets are displayed to the user on a user interface of a general computing system.

### BRIEF DESCRIPTION OF THE SEVERAL VIEWS OF THE DRAWINGS

Illustrative embodiments of the invention are described in detail below, with reference to the attached drawing figures, which are incorporated by reference herein, and wherein:

FIG. 1 is an illustration of historical travel data according to the embodiments of the invention;

FIG. 2 is an illustration of day-of-the-week travel data according to the embodiments of the invention;

FIG. 3 is an illustration of advance purchase time travel data according to the embodiments of the invention;

FIG. 4 is an illustration of a spreadsheet of lowest travel ticket prices according to the embodiments of the invention;

FIG. 5 is an illustration of probabilities for best and worst travel procurement times according to the embodiments of the invention;

FIG. 6 depicts a general computing system used in accordance with the embodiments of the invention;

FIG. 7 is a flow diagram illustrating the method used in accordance with the embodiments of the invention; and

FIG. 8 is a block diagram of the travel arrangement system used in accordance with the embodiments of the invention.

### DETAILED DESCRIPTION

Embodiments of the invention provide systems and methods for market intelligence tools for use in determining optimum travel arrangements. This detailed description satisfies the applicable statutory requirements. The terms “step,” “block,” etc. might be used herein to connote different acts of methods employed, but the terms should not be interpreted as implying any particular order, unless the order of individual steps, blocks, etc. is explicitly described. Likewise, the term “module,” etc. might be used herein to connote different components of systems employed, but the terms should not be interpreted as implying any particular order, unless the order of individual modules, etc. is explicitly described.

Throughout the description of different embodiments of the invention, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of any embodiment of the invention.

Embodiments of the invention include, among other things, a method, system, or set of instructions embodied on one or more computer-readable media. Computer-readable media include both volatile and nonvolatile media, removable and non-removable media, and media readable by a database and various other network devices. Computer-readable media comprise computer storage media and communication media. By way of example, and not limitation, computer-readable media comprise media implemented in any method or technology for storing information. Examples of stored information include computer-useable instructions, data structures, program modules, and other data representations. Media examples include, but are not limited to, information-delivery media, random access memory (RAM), read-only memory (ROM), electrically erasable programmable read-only memory (EEPROM), flash memory or other memory technology, compact-disc read-only memory (CD-ROM), digital versatile discs (DVD), holographic media or other optical disc storage, magnetic cassettes, magnetic tape, magnetic disk storage, and other magnetic storage devices. These technologies can store data momentarily, temporarily, or permanently. The computer readable media include cooperating or interconnected computer readable media, which exist exclusively on a processing system or distributed among multiple interconnected processing systems that may be local to, or remote from, the processing system. Communication media can embody computer-readable instructions, data structures, program modules or other data in an electronic data signal, and includes any information delivery media. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

An embodiment of the invention may be described in the general context of computer code or machine-useable instructions, including computer-executable instructions such as program modules, being executed by a computer or other machine. Generally, program modules including routines, programs, objects, components, data structures, and the like refer to code that perform particular tasks or implement particular data types. Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

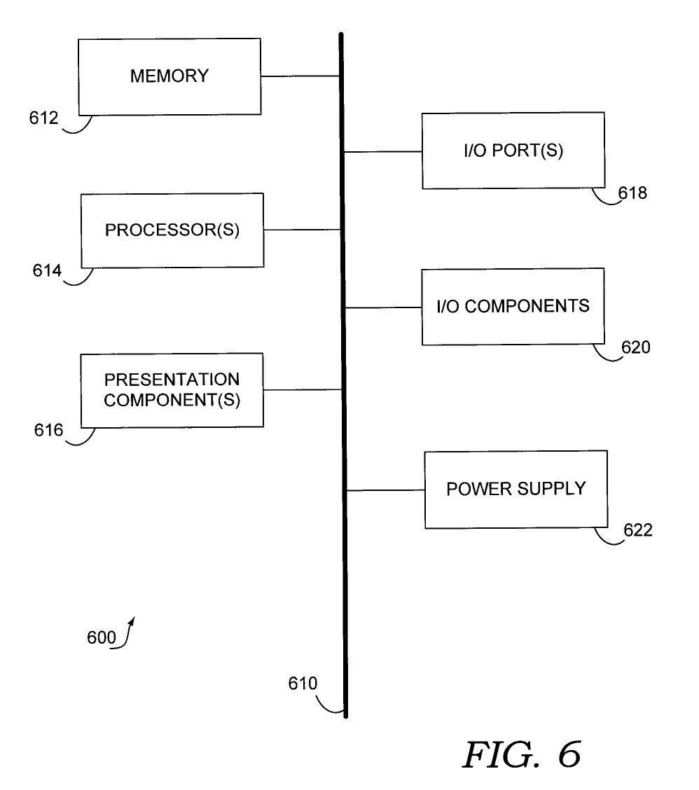

Having briefly described a general overview of the embodiments described herein, an exemplary computing device is described below. Referring initially to FIG. 6 in particular, an exemplary operating environment for implementing an embodiment of the invention is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. In one embodiment, computing device 600 is a conventional computer (e.g., a personal computer or laptop).

With continued reference to FIG. 6, computing device 600 includes a bus 610 that directly or indirectly couples the following devices: memory 612, one or more processors 614, one or more presentation components 616, input/output ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component 616 such as a display device to be an I/O component. Also, processors 614 have memory 612. It will be understood by those skilled in the art that such is the nature of the art, and, as previously mentioned, the diagram of FIG. 6 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 6, and are referenced as “computing device.”

Computing device 600 can include a variety of computer-readable media. By way of example, and not limitation, computer-readable media may comprise RAM; ROM; EEPROM; flash memory or other memory technologies; CDROM, DVD or other optical or holographic media; magnetic cassettes, magnetic tape, magnetic disk storage or other magnetic storage devices, or similar tangible media that are configurable to store data and/or instructions relevant to the embodiments described herein.

Memory 612 includes computer-storage media in the form of volatile and/or nonvolatile memory. The memory 612 may be removable, non-removable, or a combination thereof. Exemplary hardware devices include solid-state memory, hard drives, cache, optical-disc drives, etc. Computing device 600 includes one or more processors 614 that read data from various entities such as memory 612 or I/O components 620. Presentation component(s) 616 present data indications to a user or other device. Exemplary presentation components 616 include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc.

The components described above in relation to computing device 600 may also be included in a wireless device. A wireless device, as described herein, refers to any type of wireless phone, handheld device, personal digital assistant (PDA), BlackBerry®, smartphone, digital camera, or other mobile devices (aside from a laptop) capable of communicating wirelessly. One skilled in the art will appreciate that wireless devices will also include a processor and computer-storage media to perform various functions. Embodiments described herein are applicable to both a computing device and a mobile device. In embodiments, computing devices can also refer to devices that are running applications of which images are captured by the camera in a mobile device.

The computing system described above is configured to be used with several databases and to perform data analyses using market intelligence tools of the embodiments of the invention. Financial decisions regarding most areas of interest can be enhanced by considering historical data. In the instance of travel arrangements, for example, certain annual events produce repeatable patterns.

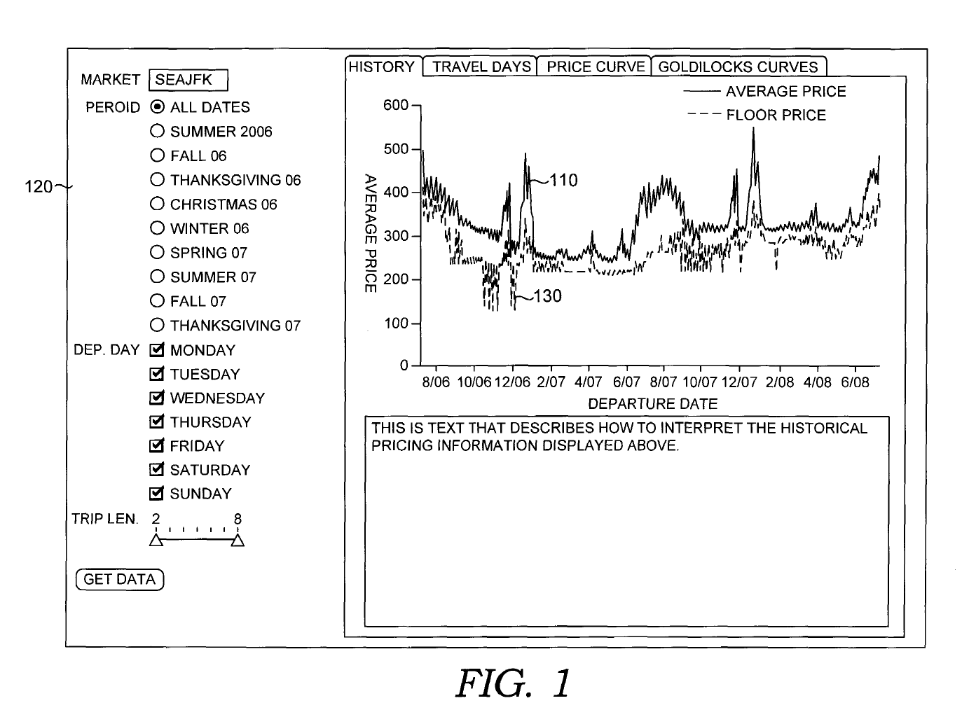

An historical database and analysis of airline tickets, as an example, would enlighten the traveler in making an economical travel decision. FIG. 1 illustrates an embodiment, showing an exemplary graphical user interface for the pattern of airline ticket prices over the past two years. The upper curve is an average price curve 110 of all airline tickets for a particular travel selection between an origination location and a destination location. In the example shown, the origination location is Seattle, and the destination location is JFK Airport in New York. There are menu options 120 available, including the option to select from several hundred origination and destination combinations. Even when a busy travel time is desired, such as July, the historical database market intelligence tool, illustrated in FIG. 1 would assist in finding an optimum travel combination during that busy time. The historical database also provides the means to plan a trip far in advance. Additional menu options 120 are available for customizing the historical data analysis to many different variable combinations, such as certain days of the week or changing the trip length. This customization of data provides options, even within rigid traveler constraints.

An additional feature of FIG. 1 displays a floor price curve 130 for airline tickets. Even though ticket prices for the second half of November and December are traditionally high, the floor price curve 130 illustrates that floor priced tickets occur just prior to the high priced tickets. The floor price curve 130 also illustrates the gap between the average ticket price, and the cheapest possible ticket price. During an expensive time of the year, this gap will be high. Therefore, there is an opportunity to save a substantial amount of money, if the traveler can be flexible as to other ticket variables, such as departure and return dates. The floor price curve 130 also shows the lowest prices that a given market is ever likely to go. Therefore, a reasonably priced ticket can be obtained, even during an expensive season, by considering the floor price curve 130 patterns. In addition to the average and floor prices for tickets, other historical pricing quantities can be obtained, such as median or standard deviation results.

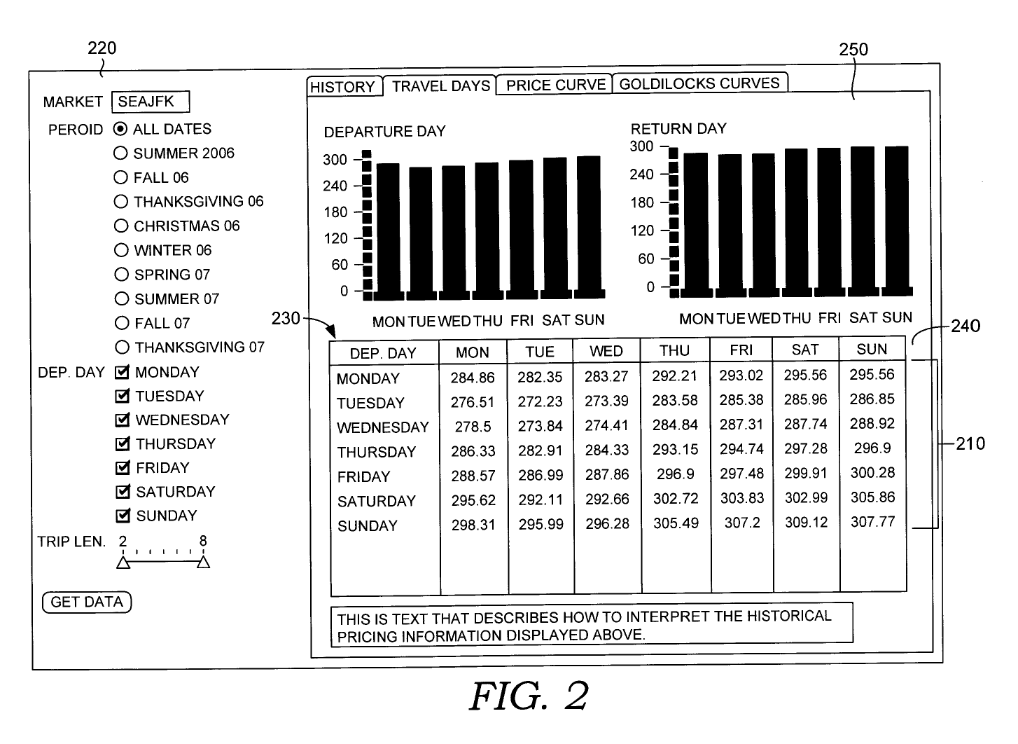

A day-of-the-week database and analysis for airline tickets is another travel tool embodiment to assist with making an economical travel arrangement. Travel ticket prices vary a great deal, depending upon the day of the week for the departure date and the return date. FIG. 2 illustrates the average airline ticket price 210 for a particular travel selection from the menu options 220. A travel ticket price 210 is given for each day of the week for a departure date 230, coincided with each day of the week for a return date 240. The graphical display 250 of those tabulated travel ticket prices 210 shows that Tuesday and Wednesday tend to be more economical days for both departure and return dates, and Sunday and Monday tend to be the most expensive days for both departure and return dates. Menu options 220 are available for customizing the day-of-the-week data analysis to many different variable combinations. As an example, a specific time period, such as summer 07 could be selected, and the length of trip could also be changed. A combined analysis of the historical data and day-of-the-week data assist a traveler in narrowing down a time period that is acceptable within his/her travel constraints, and also provide an economical travel option.

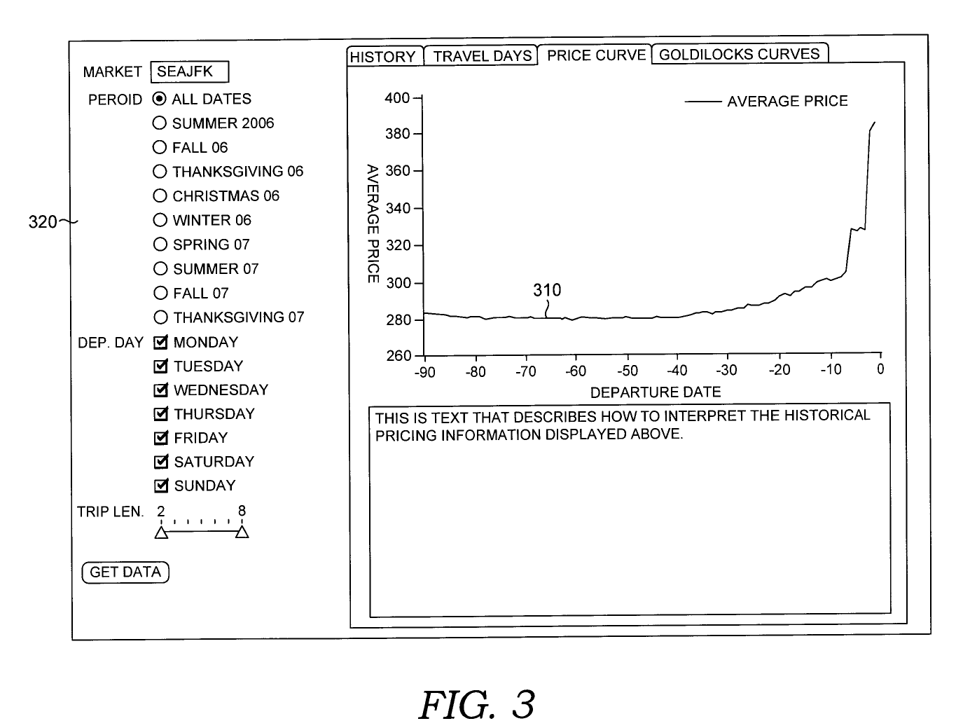

A database and analysis for the number of days prior to a travel departure date is another travel tool embodiment. This advance purchase time database is used to analyze the average price of a travel ticket as a function of the number of days prior to the departure date, as illustrated in FIG. 3. The average ticket price curve 310 shows that an airline ticket price remains fairly steady, up to approximately forty days prior to the departure date. The ticket price curve 310 increases at a steady rate from approximately 20-40 days prior to the departure date. However, the ticket price curve 310 increases dramatically within ten days of the departure date. Therefore, this analysis demonstrates that, on average, there is little advantage, and perhaps a slight disadvantage to purchasing an airline ticket more than forty days prior to the departure date in this market. The analysis also demonstrates that purchasing an airline ticket within ten days of the departure date should be avoided, if possible. Menu options 320 are available for customizing the advance purchase time data analysis to many different variable combinations. For example, certain departure days could be selected, rather than including all days of the week in the data aggregation. The analysis of historical prices as a function of days to departure, assists the traveler in determining the best time to actively shop for travel tickets, and it provides an estimate of the risk incurred in waiting for a better price to come about.

FIGS. 1-3 demonstrate how past event database information can be aggregated, analyzed, and displayed as market intelligence tools, to provide great insight into making travel arrangements. An additional embodiment provides updates to the historical database, the day-of-the-week database, and the advance purchase time database. The updates could be provided on a regular basis, or according to a specific schedule.

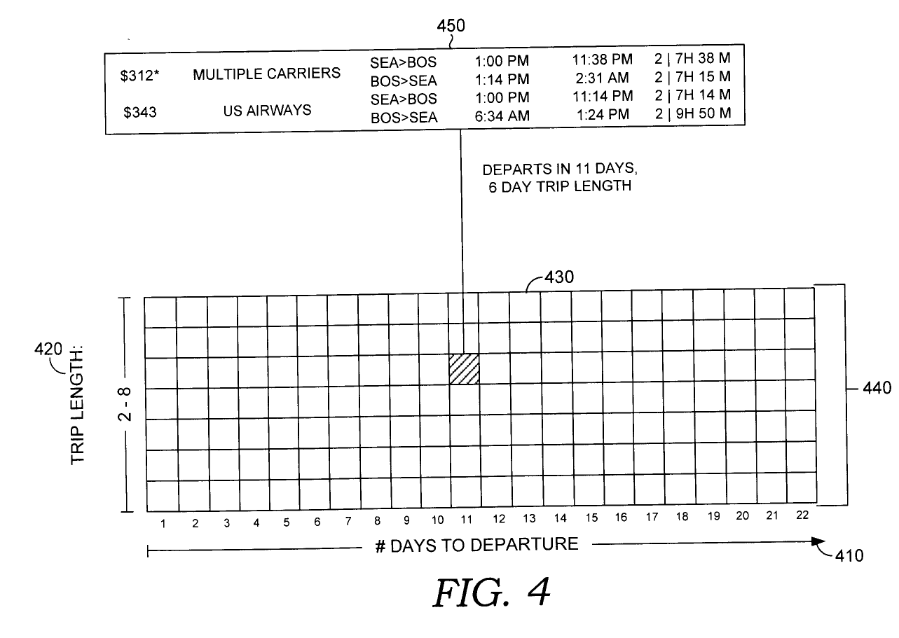

The embodiments of the invention also provide a database listing of the cheapest travel arrangements available. FIG. 4 illustrates the cheapest airline tickets, as an example. A spreadsheet 440 in FIG. 4 displays a number of days to the departure date, listed as the departure time 410, as a function of the length of trip 420. Each cell 430 within the spreadsheet 440 provides a list of the cheapest flights 450 available for the selected variables of departure time 410 and length of trip 420, for a particular travel selection. This spreadsheet 440 of the cheapest flights 450 assists the traveler in targeting some exact travel dates that meet his/her criteria, at the best possible prices. The database listing of cheapest flights 450 could comprise any number of flights that would provide an adequate selection of choices. In FIG. 4, the cheapest fifty flights is given in each cell 430.

Another embodiment provides a graphical user interface link, in which a user can select and procure a particular travel arrangement, such as one of the selections displayed in the cheapest flights 450 of FIG. 4. Another embodiment also provides selecting and procuring hotel arrangements, as an addition to the primary travel arrangement.

A data analysis engine can determine an optimum travel arrangement by combining the past event database analyses and current database lists. The data analysis engine can be implemented on top of a database technology, such as a grid of workstations with shared storage, using a Structured Query Language (SQL) style of query language. Data processing can be distributed over the cluster of workstations. The data can be stored in a set of files, partitioned by origin, destination, and observation date. A form of SQL is able to run complex queries over the data store. This is one example of how the data analysis engine can be implemented; however, other implementations are included in the scope of the invention.

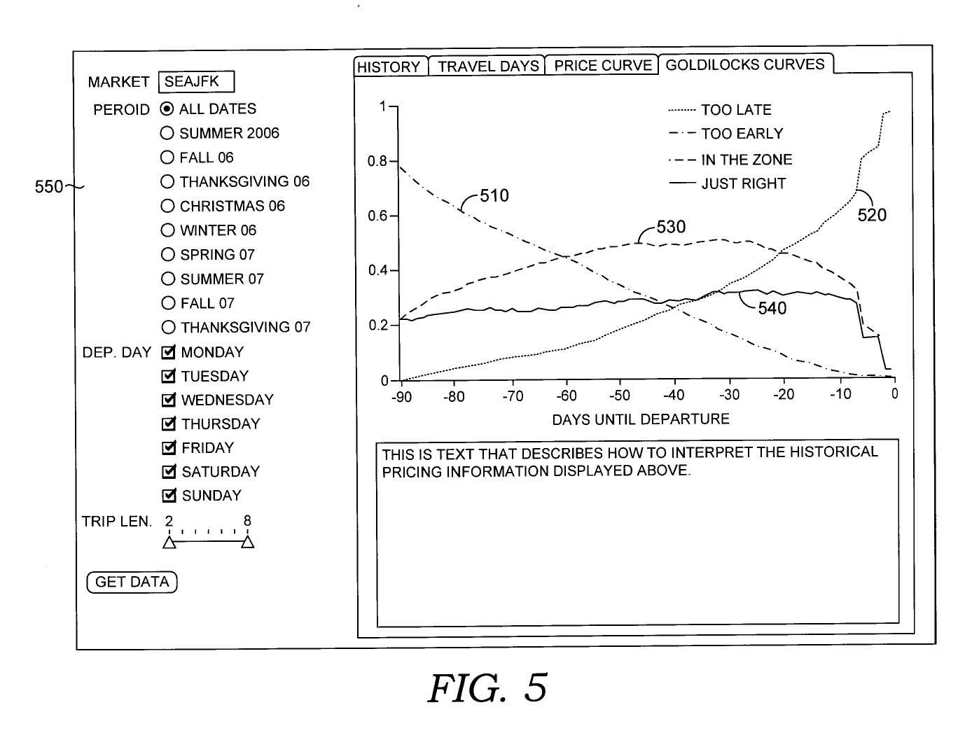

FIG. 5 displays several probability curves, generated by the data analysis engine, and based upon past event database analyses and current database lists, as described above with reference to FIGS. 1-4. Curve 510 displays the probability of purchasing a travel ticket too early, when the lowest prices have not yet occurred, as a function of the number of days prior to the departure date. Curve 520 displays the probability of purchasing a travel ticket too late, when the lowest ticket prices are no longer available, as a function of the number of days prior to the departure date. As discussed above, with reference to FIG. 3, the cost of an airline ticket in the SEAJFK market, for example, starts to increase at approximately 20-40 days prior to the date of departure. Therefore, curve 520 starts to increase, as an indication of the increase in probability of purchasing too late. Within ten days of departure, the probability of purchasing an airline ticket too late increases dramatically. Curve 530 displays the difference of curves 510 and 520, to display a region of acceptable times for travel ticket procurement, relative to the number of days prior to the departure date. Curve 540 displays the probability of making an optimum travel arrangement decision, as a function of the number of days prior to the departure date. The menu options 550 are available for customizing the probability data analysis to many different variable combinations. As previously discussed, selections can be made for a particular time of the year or for specific days of the week, and the length of trip can be varied.

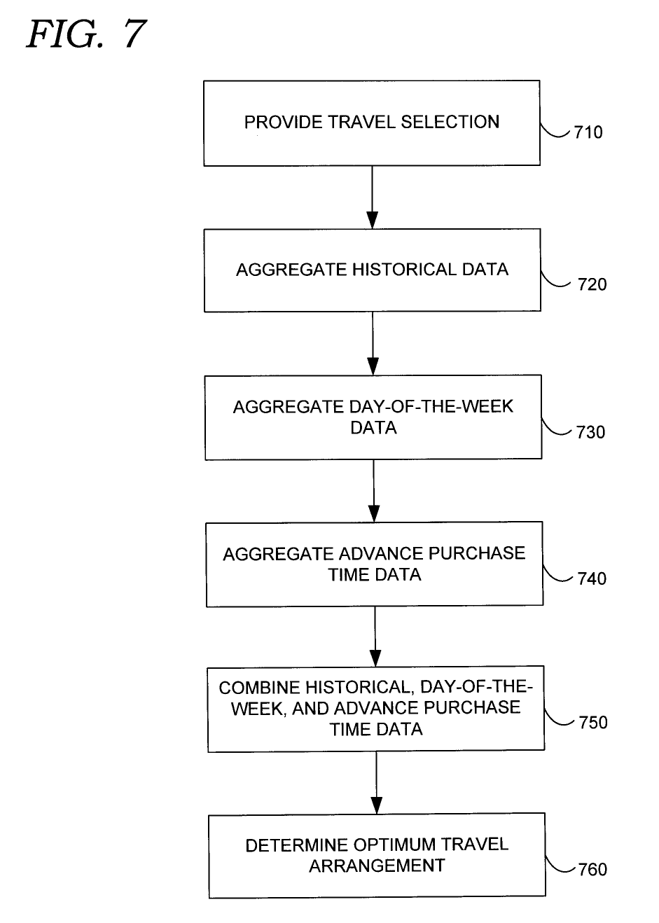

FIG. 7 is a flow diagram illustrating the above described method. A travel selection of the origination and destination points is provided by a user or customer in step 710. A data analysis engine aggregates historical data in step 720, to provide historical trends in travel costs. The data analysis engine also aggregates day-of-the-week data to provide an estimate of the best days of the week for departure and arrival in step 730. The data analysis engine also aggregates advance purchase time data in step 740, to provide an estimate of the best time to purchase a ticket prior to the departure date. The data analysis engine then combines all of the historical, day-of-the-week, and advance purchase time data in step 750 to form a results database. The results database is used to form probability results for different combinations of user input specifications. This allows the user to determine the optimum combination of travel variables, given by step 760.

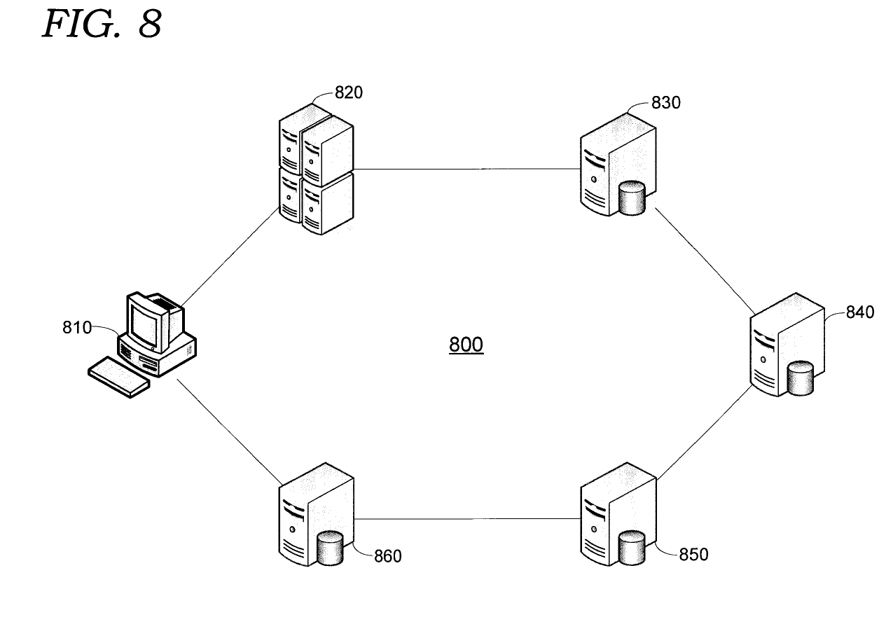

FIG. 8 is a block diagram of the travel arrangement system 800, used in the process described above. A general computing system 810, similar to the computing system described with reference to FIG. 6 is used. A user interface is included as part of the computing system 810. A data analysis engine 820 aggregates and analyzes data obtained from the different databases. The historical database 830 stores data for airline ticket prices, for multiple origination and destination locations, over various time periods. The time periods could span an entire year or years, or it could include specific times of the year, as well as other time-related variables. The day-of-the-week database 840 stores data for airline ticket prices, based on the day of the week for both the departure date and return date. The advance purchase time database 850 stores data for airline ticket prices, based on the number of days prior to departure, in which the tickets were purchased. Results from this combined aggregating and analyzing are stored in a results database 860, which is used for further analysis and prediction to provide optimum travel arrangements. As described above, the results database 860 includes analyzing the combined data from the databases 830, 840, and 850 to determine the optimum combination of variables in which to make a travel arrangement.

Many of the examples given herein are for airline travel tickets. However, embodiments of the invention can be applied to other travel industries, including but not limited to, train and bus travel.

A source of advertising or sponsorship could also be utilized with the embodiments of the invention. A referral could be provided from the company from which travel arrangements were procured, as an example of one embodiment. Advertising links could also be provided at different levels of the procurement process, as another embodiment. The advertising links could be either primary links from the travel entity itself, or secondary advertising links from other sources.

Many different arrangements of the various components depicted, as well as embodiments not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the embodiments of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A computer-implemented method for selecting an optimum travel arrangement, comprising:
using a computing system, comprising a user interface for said method;
providing a travel selection, comprising an origination location and a destination location;
aggregating historical data, comprising a plurality of travel prices for a plurality of respective dates within a past time period for said travel selection;
aggregating day-of-the-week data, comprising a plurality of travel prices for each respective seven days of a week as a departure date and for each respective seven days of a week as a return date for said past time period;
aggregating advance purchase time data, comprising a plurality of travel prices for a plurality of respective number of days prior to said departure date for said past time period; and
determining said optimum travel arrangement based upon combined results of said historical data, said day-of-the-week data, and said advance purchase time data for said past time period.

2. The method of claim 1, wherein said optimum travel arrangement comprises a plurality of lowest travel prices calculated over a range of number of days prior to said departure date, for a corresponding length of time from said departure date to said return date.

3. The method of claim 1, further comprising displaying probability data, comprising a plurality of most economical times of travel procurement and a plurality of least economical times of travel procurement, for a plurality of respective number of days prior to said departure date.

4. The method of claim 1, wherein said travel prices comprise an average price and a corresponding floor price.

5. The method of claim 1, further comprising: providing a link to secure said optimum travel arrangement.

6. The method of claim 1, further comprising: displaying said historical data, said day-of-the-week data, said advance purchase time data, and said optimum travel arrangement on a user interface.

7. The method of claim 1, wherein said historical data, said day-of-the-week data, and said advance purchase time data are updated on a regular schedule.

8. The method of claim 1, wherein said plurality of travel prices comprises a plurality of airline ticket prices.

9. The method of claim 1, wherein said optimum travel arrangement further comprises an optimum hotel arrangement.

10. A travel arrangement system, comprising:
a computing system, comprising a user interface;
a data analysis engine;
an historical database, comprising a plurality of travel prices for a plurality of respective dates within a past time period for a travel selection, said travel selection comprising an origination location and a destination location;
a day-of-the-week database, comprising a plurality of travel prices for each respective seven days of a week as a departure date and for each respective seven days of a week as a return date for said past time period;
an advance purchase time database, comprising a plurality of travel prices for a plurality of respective number of days prior to said departure date for said past time period; and
a results database for combined results of said historical database, said day-of-the-week database, and said advance purchase time database for said past time period, via said data analysis engine.

11. The system of claim 10, wherein said results database for combined results comprises a plurality of lowest travel prices calculated over a range of number of days prior to said departure date, for a corresponding length of time from said departure date to said return date.

12. The system of claim 10, wherein said historical database, said day-of-the-week database, said advance purchase time database, and said results database for combined results provide information to display on said user interface.

13. The system of claim 10, wherein said plurality of travel prices comprises a plurality of airline ticket prices.

14. The system of claim 10, further comprising a probability database, comprising a plurality of most economical times of travel procurement and a plurality of least economical times of travel procurement, for a plurality of respective number of days prior to said departure date.

15. The system of claim 14, wherein said probability database comprises an optimum range of said plurality of respective number of days prior to said departure date.

16. A computer readable medium for performing the steps of a method for selecting an optimum travel arrangement, comprising:
using a computing system, comprising said computer readable medium for performing said steps;
providing a travel selection, comprising an origination location and a destination location;
aggregating historical data, comprising a plurality of travel prices for a plurality of respective dates within a past time period for said travel selection;
aggregating day-of-the-week data, comprising a plurality of travel prices for each respective seven days of a week as a departure date and for each respective seven days of a week as a return date for said past time period;
aggregating advance purchase time data, comprising a plurality of travel prices for a plurality of respective number of days prior to said departure date for said past time period; and
determining said optimum travel arrangement based upon combined results of said historical data, said day-of-the-week data, and said advance purchase time data for said past time period.

17. The computer readable medium of claim 16, wherein said optimum travel arrangement comprises a plurality of lowest travel prices calculated over a range of number of days prior to said departure date, for a corresponding length of time from said departure date to said return date.

18. The computer readable medium of claim 16, further comprising displaying probability data, comprising a plurality of most economical times of travel procurement and a plurality of least economical times of travel procurement, for a plurality of respective number of days prior to said departure date.

19. The computer readable medium of claim 18, wherein said displaying probability data comprises displaying an optimum range of said plurality of respective number of days prior to said departure date.

20. The computer readable medium of claim 16, wherein said plurality of travel prices comprises a plurality of airline ticket prices.
